(19) United States
(12) Patent Application Publication
(10) Pub. No.: US 2026/0170876 A1
(43) Pub. Date: Jun. 18, 2026

(54) VISUAL HUMAN VERIFICATION USING GENERATIVE ARTIFICIAL INTELLIGENCE

(71) Applicant: International Business Machines Corporation, Armonk, NY (US)

(72) Inventors: James Anthony Maniscalco, New York, NY (US); Thomas Jefferson Sandridge, Tampa, FL (US); Stephen Forster, New York, NY (US); Brandon Harris, Union City, NJ (US)

(21) Appl. No.: 18/979,775

(22) Filed: Dec. 13, 2024

(51) Int. Cl. G06V 40/40; G06V 10/75; G06V 10/776; G06V 20/40; G06V 40/70

(52) U.S. Cl. CPC G06V 40/40; G06V 10/75; G06V 10/776; G06V 20/49; G06V 40/70

(57) ABSTRACT

An approach for distinguishing between malicious AI scripts and actual humans during an online identity verification may be provided. The approach, leveraging a LLM (large language model) validates a user by receiving an identification document. The approach identifies factors for verification and initiates a video call with the user. The approach instructs the user to perform various tasks within a time limit, wherein the performance is graded and used to calculate a confidence score. The scores are compared against minimum confidence scores. Furthermore, any remaining tasks are asked to be performed until the time limit has expired. Notification will be provided to validate identity of the user.

### TECHNICAL FIELD

The present invention relates generally to communication, and specifically, to authenticating communication session between users.

### BACKGROUND

Generative AI (artificial intelligence) is a type of AI technology that generates various contents (e.g., text, video, audio, etc.). Generative AI can leverage GANs (generative adversarial network) to produce convincingly real images, videos, and audio of real people. There have been several uses of generative AI in society, such as, the entertainment industry.

### BRIEF SUMMARY

According to an embodiment of the present invention, a computer-implemented method for visual human verification using generative artificial intelligence, comprising: transmitting, by one or more processors, to a user, a request for identification documentation; receiving, by the one or more processors, the identification documentation of a user; assigning, by the one or more processors, an identification factor to the identification documentation; identifying, by the one or more processors, factors for verification, wherein the factors comprises of the identification factor and one or more task factors; initiating, by the one or more processors, a video call with the user; instructing, by the one or more processors, the user to perform one or more tasks within a time limit, wherein each task of the one or more tasks are associated with the one or more task factors; calculating, by the one or more processors and via a multimodal LLM, a confidence score for each factor of the factors; comparing, by the one or more processors, a calculated confidence scores to against minimum confidence scores, wherein a minimum confidence score can be user defined or automatically defined by the multimodal LLM; iteratively, repeating, by the one or more processors, any remaining tasks from the one or more tasks for the user to perform until the time limit has expired; outputting, by the one or more processors, a final score based on the calculated confidence scores; determining, by the one or more processors, whether the calculated confidence scores exceeds a required threshold, wherein a required threshold score can be administrative user defined or automatically defined by the multimodal LLM; and notifying, by the one or more processors, an administrative user that the calculated confidence scores did not exceed the required threshold.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a computing environment 100, showcasing various hardware and software components, which enable the implementation of the embodiments of the present invention;

FIG. 2 is a high-level system architecture, depicting interactions between devices and the user, according to embodiments of the present invention;

FIG. 3A is a block diagram illustrating a use case scenario where the system identifies objects in the user's background for interaction as part of the identity verification process according to embodiments of the present invention;

FIG. 3B is a block diagram depicting a scenario where there are no identifiable objects in the user's background, prompting the user to verify their identity using a QR code as an alternative verification method according to embodiments of the present invention;

FIG. 4 presents a high-level flowchart representing a method 400, which illustrates the steps involved in receiving and processing identification documents through AI and multimodal LLM technologies, in accordance with one embodiment of the present invention;

FIG. 5 is a high-level flowchart of a method 500, detailing the verification process, where the system prompts the user to participate in a video call and perform various tasks, which are then analyzed to calculate confidence scores using AI models;

FIG. 6 illustrates an alternative embodiment depicting a flowchart of method 600 where the system evaluates whether the case is a high-risk case to be escalated to an administrative user for manual review according to embodiments of the present invention; and

FIG. 7 is a high-level flowchart of a method 700, showing the steps of transmitting a request for user identification, processing the identification document, assigning identification factors, and calculating a final score after tasks are completed, according to the embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The existing art for online identity verification primarily focuses on facial recognition methods designed to prevent spoofing attempts. Current systems utilize model-based approaches for recognizing individuals during video interactions; however, they fall short in several critical areas. Specifically, these methods do not provide feedback mechanisms that allow users to interact meaningfully with objects in their environment.

The following description discloses several embodiments for distinguishing between malicious AI scripts and real humans during an online identity verification. Some embodiments of the present invention can provide the capability of enhancing security by detecting deepfake images or videos during video-based identity verification processes.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

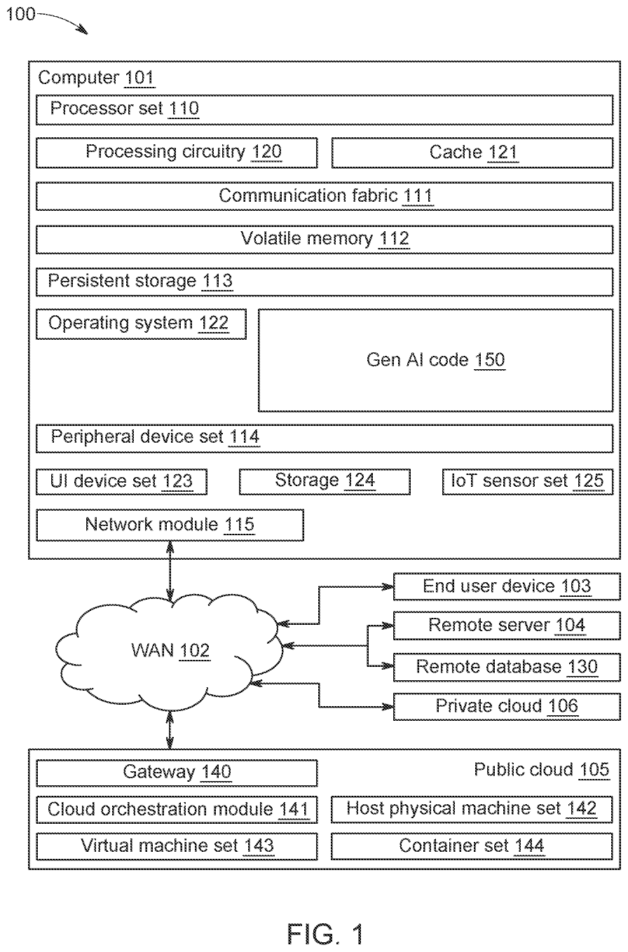

FIG. 1 includes computing environment 100, which contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Gen AI code 150, as identified above), peripheral device set 114 (including user interface (UI) device set 123), storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computing environment 100 contains an example of an environment for the execution of at least some of the computer code involved in performing the inventive methods, such as Gen AI code 150. In addition to Gen AI code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Gen AI code 150, as identified above), peripheral device set 114 (including user interface (UI) device set 123), storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically, computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Gen AI code 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in Gen AI code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 250 is any wide area network (for example, the internet) capable of communicating computer data over non-local distances by any technology for communicating computer data, now known or to be developed in the future. In some embodiments, the WAN 250 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end users (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In an embodiment, Gen AI code 150 has a capability of effectively distinguishing between malicious AI scripts and real humans during an online identity verification. For example, a financial institution has to implement a policy to comply with federal and/or state's AML (anti-money laundering) regulation, such as, KYC (“know your customer”). KYC policy for financial institution requires customers to validate their identity when meeting with personnel of a financial institution to sign up and/or transact financial service/products. In addition, Gen AI code 150 can enhance security by detecting deepfake images or videos during video-based identity verification processes. This allows financial institutions to comply with regulations while protecting against sophisticated identity fraud. The system can also analyze user behavior patterns, comparing them against known legitimate or suspicious behaviors to flag potentially malicious activities.

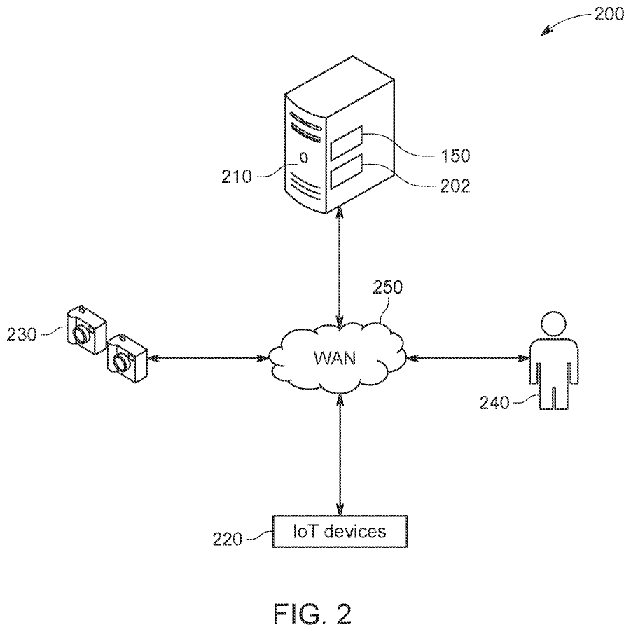

Referring now to various embodiments of the disclosure in more detail, FIG. 2 is a representation of Communication System 200, that is capable of sematic analysis to differentiate between advanced artificial generations and real humans. Many modifications to the depicted environment may be made by those skilled in the art without departing from the scope of the disclosure. Communication system 200 includes WAN 250, Server 210, Internet of things (IoT) device 220, Image Capturing Device 230, and User 240. In this embodiment, Server 210 includes Gen AI code 150 and LLM 202.

Server 210 can be a standalone computing device, a management server, a web server, a mobile computing device, or any other electronic device or computing system capable of receiving, sending, and processing information. In other embodiments, Server 210 can represent a server computing system utilizing multiple computers as a server system, such as in a cloud computing environment (e.g., cloud environment 105 or 106). In some embodiments, LLM 202 (large language model) receives, sends, and process data collected by Server 210. In the current depiction, LLM 202 resides on server 210. However, it is noted that LLM 202 may reside on other servers (not pictured) as long as Gen AI code 150 has access to LLM 202.

LLM 202 is a customized Multimodal LLM (large language model) designed to understand and generate text (i.e., interactions between humans) of humans, in addition to other forms of content, based on the vast amount of data used to train it. It has the ability to infer from context, generate coherent and contextually relevant responses, translate to languages other than English, summarize text, answer questions (general conversation and FAQs) and even assist in creative writing or code generation tasks. Any existing LLM can be leveraged, such as IBM Watson, OpenAI's GPT, Google's Gemini, etc. For example, relevant to an embodiment of the present invention, LLM 202, through proper training, identifies factors that establish that User 240 is a real person, and to ensure that User 240 is the same person from an uploaded identification based on information sent by Image Capturing Device 230. It is noted that one skilled in the art would be able to train existing LLM to perform the various functionalities of LLM 202 in combination with Gen AI code 150. Furthermore, training methods can vary from organization of a user based on their business goals and objectives. Thus, it is beyond the scope of this disclosure to cover every aspects on training of an LLM.

Image capture device 230 can include digital or analog cameras including image-capturing hardware, such as lenses, image sensors such as CMOS sensors, microprocessors, memory chips, other circuitry, and image processing software. The image capture devices may include other known components as well. In one embodiment, the image capture devices include hardware and software for performing analysis on collected data, such as video content analysis (VCA). As one example, a video capture device may include a video sensor, such as a camera, which may be optionally connected to a video recorder, such as a digital video recorder (DVR) or a network video recorder (NVR). The video recorder may be programmed to perform certain analysis.

In some embodiments, IoT device 220 can be any number of IoT devices. In some embodiments, IoT device 220 may include computerized devices, such as personal computers, smartphones, servers, or the like. Two such devices network together when one device is able to exchange information with the other device, whether or not they have a direct connection to each other. Two such devices exchange data with each other using Server 210. The connections between the devices are established using either a wired connection, a wireless connection, or combination thereof. It is noted that GEN AI Code 150 leverages LLM 202 to perform various function, such as, but not limited to, online identity verification.

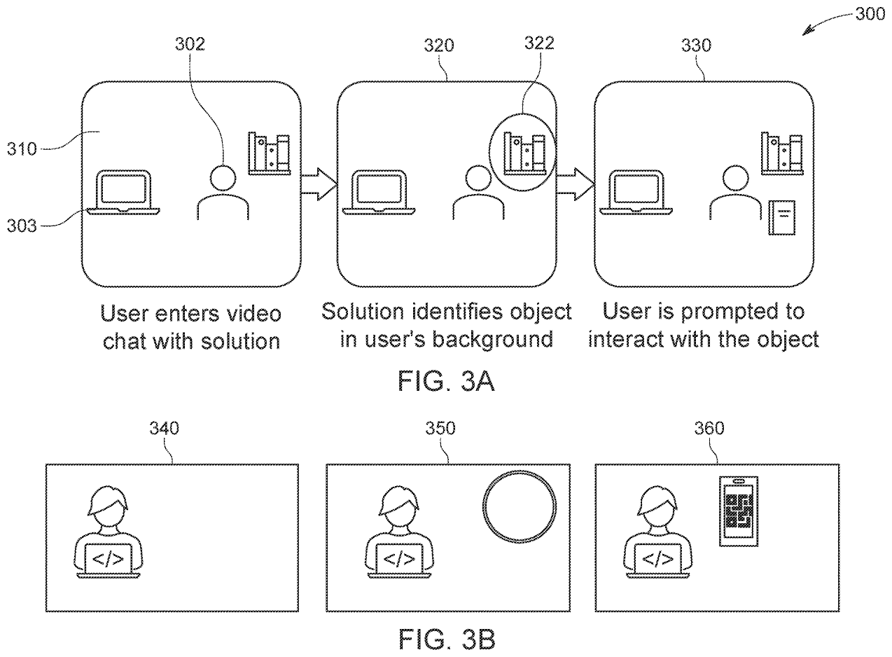

FIGS. 3A and 3B show a block diagram of an exemplary system, depicting interactions between devices, objects and users in accordance with aspects of the invention, as scenario 300. Scenario 300 illustrates the execution of the steps of Gen AI code 150, that may be carried out in the environment of FIG. 2 and are described with reference to elements depicted in FIG. 1.

Referring to FIG. 3A, the system described in the figure illustrates a verification process in which Computer 303 interacts with User 302 to verify their humanity by prompting an interaction with an object in the user's background. In scenario 310, the process begins when User 302 enters a video chat with the solution, as depicted in the first panel. Computer 303 is equipped with an IoT Device 220, which may include various computerized devices such as personal computers, smartphones, or servers. These devices can exchange information via Server 210, using either wired or wireless connections. In scenario 320, the solution identifies an object in the user's background, referred to as Object 322 (such as, a bookshelf). This detection is facilitated by Image Capture Device 230, which visually records the user's environment. Finally, as shown in scenario 330, User 302 is prompted to interact with Object 322 in the background. The interaction is monitored by the IoT Device 220 and captured by Image Capture Device 230. Gen AI 150 then processes the interaction using a machine learning algorithm to verify that the user is human by analyzing their ability to perform interactions with the object.

Referring to FIG. 3B, in scenario 350, after the user has entered the video chat as shown in scenario 340 (which is the same as scenario 310) the solution attempts to identify an object in the user's background for interaction. If no suitable objects are present, the system dynamically generates alternative tasks. These tasks could include performing hand gestures like holding up fingers, placing hands on the walls, or interacting with the clothes the user is wearing. In scenario 360, another embodiment is illustrated, where the system sends a QR code, picture, or shape to the user's phone. The user may be asked to display this code to the camera or place it in a specific location within the background. These tasks, whether object-based or generated, are captured by the Image Capture Device 230 and processed by the system, which runs a machine learning algorithm to verify that the user's interaction confirms they are human.

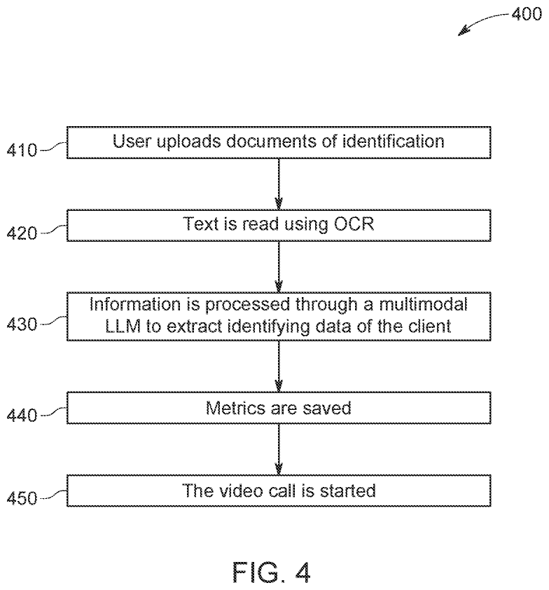

FIG. 4 illustrates a flowchart depicting the execution of Gen AI code 150 as method 400, which facilitates the analysis of identification documents using LLM 202. In this embodiment, method 400 begins at scenario 410, where LLM 202 transmits to User 302 a request for identification documentation. User 302 uploads identification documents into Server 210 via a secure interface. The server ensures the integrity and security of the documents through encryption protocols before further processing.

At scenario 420, Server 210 employs Optical Character Recognition (OCR) to extract text from the uploaded documents. The OCR system scans the document, recognizing characters and converting them into machine-readable text.

At scenario 430, the embodiment interacts with LLM 202 to further analyze the extracted text. LLM 202 processes the structured document data to extract key identifying information, such as the name, birth date, and document number of User 302. The embodiment dynamically adjusts to the type of document (e.g., passport, driver's license) and extracts the relevant information specific to that document. LLM 202's output is then fed back into Gen AI code 150 for further processing.

At scenario 440, the embodiment processes the extracted information and generates a set of metrics, including user details like age, gender, height, eye color, hair color, date of birth, place of birth, nationality, residential address, signature, photograph, fingerprints, and any other biometric data such as facial recognition and iris scan. These metrics are stored in Server 210 for future use, ensuring they are saved for later verification. The system may also perform additional validation checks to ensure the extracted data aligns with other user-provided information.

At scenario 450, Server 210 initiates a video call, using the saved metrics during the session. The metrics may be used for real-time identity verification during the video interaction.

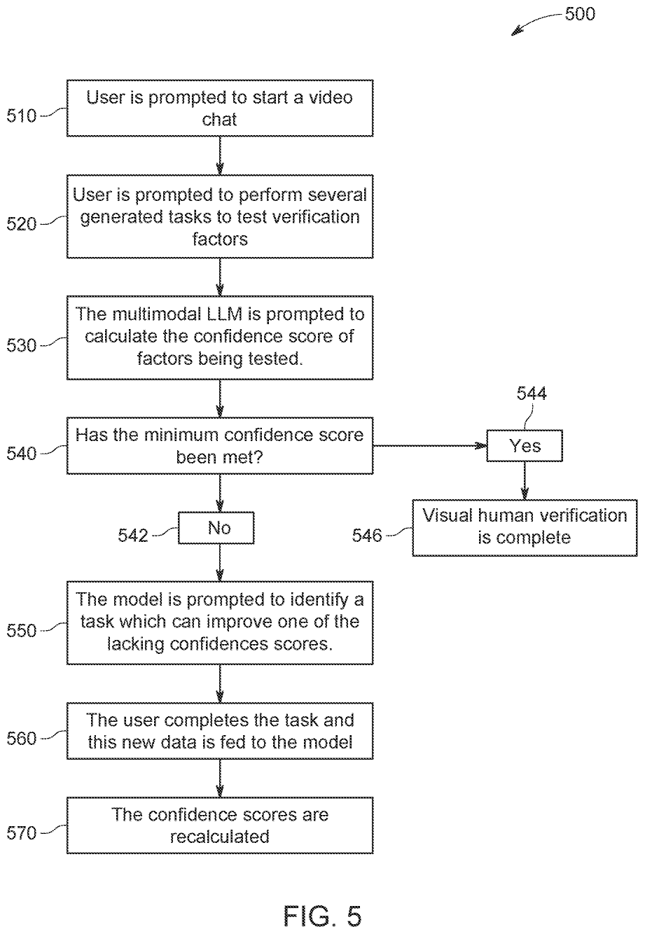

FIG. 5 depicts a flowchart illustrating the execution of Gen AI code 150, as Method 500, for initiating the calculation of the confidence score used in human verification. At step 510, the system prompts User 302 to initiate a video chat. Once the video call begins, Gen AI code 150 prompts the user at step 520 to perform a series of dynamically generated tasks aimed at verifying various human factors iteratively repeating tasks for the user to perform until the time limit has expired. The tasks are tailored to objects detected in the background of the video stream. For instance, the system may identify a water bottle on the user's desk and ask the user to pick it up. Alternatively, tasks may be generated without relying on specific objects, such as asking the user to perform gestures like holding up three fingers or touching a specific wall in their environment. Other key verification factors include determining whether the user is a real person, confirming that the person in the video matches the individual from uploaded identification documents, and ensuring that the individual has not previously created an account. Additionally, the system might prompt the user to display a QR code on their mobile device for further identity verification.

At step 530, Gen AI code 150 initiates interaction with LLM 202 to process the collected data and calculate a confidence score for each task. The confidence score for an individual task is output from the last layer of the Multimodal LLM and value ranges from 0 to 1 (or 0-100%). If multiple tasks are involved, the system aggregates these scores in various ways, depending on the implementation's needs. A simple approach may involve selecting the task with the highest confidence score, while other methods may calculate a straightforward average or applying a weighted average that assigns greater significance to tasks performed later in the sequence.

At step 540, the embodiment evaluates whether the calculated aggregate confidence score meets a predefined minimum threshold. If the confidence score satisfies the requirement, as determined at step 544, the visual human verification process is deemed successful, and the user is verified, as shown in step 546.

If, at step 542, the minimum confidence score is not achieved, Gen AI code 150 dynamically generates additional tasks designed to address the areas where verification failed, as shown in step 550. These tasks may include interacting with new objects, performing additional gestures, or any other form of user verification. For example, tasks could involve asking the user to touch a wall, flip a tie over their shoulder, unzip a bag in the background, or pick up a specific object like a bottle or a mobile device displaying a QR code.

Once User 302 completes the additional tasks, the newly gathered data is fed back into Gen AI code 150, incorporating newly gathered data after the completion of additional tasks, as shown in step 560. Gen AI code 150 recalculates the confidence score based on the latest tasks completed, step 570. The embodiment cycles between prompting the user and recalculating the confidence score until the score exceeds the required threshold while accounting for the time limit.

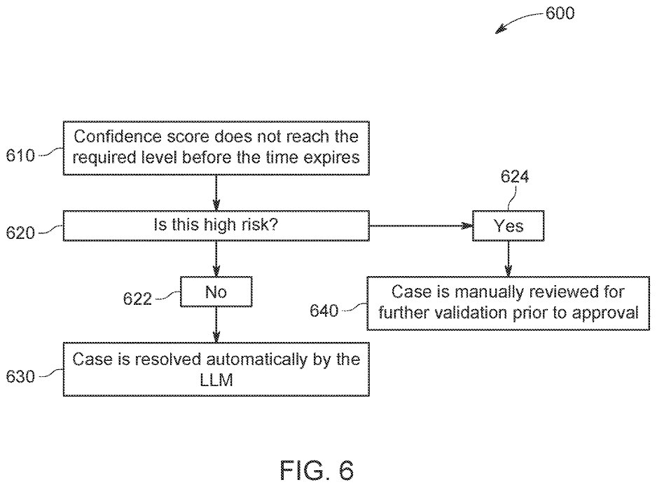

FIG. 6 depicts, as an alternative embodiment, of a flowchart illustrating the execution of, Gen AI code 150, as method 600. If the confidence score does not reach the required level before the time expires, as shown in step 610, the system checks whether the case is categorized as high-risk at decision point, step 620. If the case is determined to be high-risk, as shown in step 624, the data is passed to an appointed administrative user for manual review. The administrative user addresses edge cases that the automated system cannot resolve, such as poor video quality due to insufficient lighting or technical issues with the user's camera. The administrative user handles these cases manually according to predefined procedures. If the case is not categorized as high-risk, at step 622, it is resolved automatically by the system, as shown in step 630.

The decision to notify the administrative user for manual review depends on a tunable parameter for risk tolerance settings within the system. In lower-risk scenarios, the threshold for sending cases to human review may be high to minimize manual reviews, allowing most cases to be resolved automatically. Conversely, in higher-risk implementations, the threshold may be set lower, directing more cases to manual review for further validation, as shown in step 640, prior to approval.

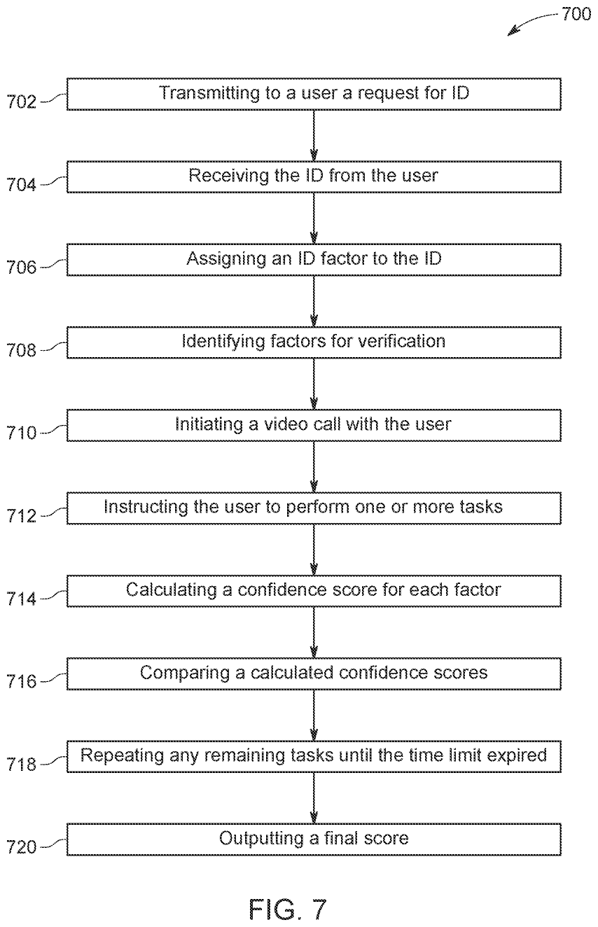

FIG. 7 illustrates an embodiment of the invention, which provides a flowchart depicting the execution of the Gen AI code 150 as method 700. This method is designed to facilitate the verification of user identity by analyzing various factors, including user-provided identification documents and real-time task performance, evaluated through artificial intelligence (AI) and multimodal large language models (LLMs).

In step 702, the embodiment initiates the process by transmitting a request to the user for identification documentation. This transmission can occur through multiple communication channels, such as an email, or a secure web portal, where the system requests the user to submit specific forms of identification, such as a passport, driver's license, or other officially recognized identification documents. At step 704, the system receives the identification documentation provided by the user. The LLM then processes and analyzes these documents to extract critical data, such as the user's name, birthdate, document number, and other identifiable information. In step 706, the system assigns an identification factor to the documentation received. The system may use Optical Character Recognition (OCR), to generate this identification factor, which serves as a unique reference point for verifying the user's identity.

In step 708, the system identifies factors for verification. These factors include the identification factor created in step 706 and additional task-based factors. Task factors may consist of user activities or behavioral indicators, such as performing specific tasks in a timed environment, and matching physical gestures. The system may generate or retrieve predefined tasks that align with the user's context and the type of verification being performed.

At step 710, the system initiates a video call with the user. The purpose of the video call is to further authenticate the user in real time, ensuring that the user who submitted the identification documents is the same person participating in the call. During the video call, in step 712, the system instructs the user to perform one or more tasks within a set time limit. These tasks are derived from the task factors identified in step 708 and are designed to further confirm the user's identity. Tasks can include activities such as answering security questions, or performing specific gestures. Each task is linked to one or more task factors that will be evaluated by the LLM.

In step 714, the system calculates a confidence score for each factor using an LLM. The LLM processes various data inputs, including visual, audio, and textual data, to calculate a confidence score for each of the factors identified earlier. The confidence score represents the likelihood that the user is genuine and that the identification and task factors align with the user's identity.

In step 716, the system compares the calculated confidence scores against predetermined or defined minimum confidence scores. These minimum scores can be either user-defined or automatically determined by the LLM, depending on the context of the verification. The system evaluates whether the user's performance and provided identification meet or exceed the minimum thresholds required for successful verification.

In step 718, if the confidence scores do not meet the minimum thresholds, the system iteratively repeats any remaining tasks that the user needs to perform until the time limit has expired. This repetition process allows the user to improve their confidence score by attempting additional tasks or retrying tasks that were previously unsuccessful.

Finally, in step 720, the system outputs a final score based on the calculated confidence scores. This final score represents the cumulative result of all verification steps, determining whether the user has successfully passed the identity verification process.

1. A computer-implemented method comprising:
transmitting, by one or more processors, to a user, a request for identification documentation;
receiving, by the one or more processors, the identification documentation of a user;
assigning, by the one or more processors, an identification factor to the identification documentation;
identifying, by the one or more processors, factors for verification, wherein the factors comprises of the identification factor and one or more task factors;
initiating, by the one or more processors, a video call with the user;
instructing, by the one or more processors, the user to perform one or more tasks within a time limit, wherein each task of the one or more tasks are associated with the one or more task factors;
calculating, by the one or more processors and via a multimodal LLM, a confidence score for each factor of the factors;
comparing, by the one or more processors, a calculated confidence scores to against minimum confidence scores, wherein a minimum confidence score can be user defined or automatically defined by the multimodal LLM;
iteratively, repeating, by the one or more processors, any remaining tasks from the one or more tasks for the user to perform until the time limit has expired;
outputting, by the one or more processors, a final score based on the calculated confidence scores;
determining, by the one or more processors, whether the calculated confidence scores exceeds a required threshold, wherein a required threshold score can be administrative user defined or automatically defined by the multimodal LLM; and
notifying, by the one or more processors, an administrative user that the calculated confidence scores did not exceed the required threshold.

2. The computer-implemented method of claim 1, wherein identifying factors for verification further comprises of, age, gender, height, eye color, hair color, date of birth, place of birth, nationality, residential address, signature, photograph, fingerprints, and any other biometric data such as facial recognition and iris scan.

3. The computer-implemented method of claim 1, wherein calculating, by the one or more processors and via the multimodal LLM, a confidence score for each factor of the factors, further comprises:
determining the confidence score for a single task of the one or more tasks based on an output of a last layer of the multimodal LLM; and
calculating an aggregate confidence score for multiple tasks of the one or more tasks by selecting the task of the one or more tasks with the highest confidence score, computing a simple average of all task scores for the one or more tasks, and applying a weighted average that assigns greater significance to tasks of the one or more tasks performed later in the sequence.

4. The computer-implemented method of claim 1, wherein the multimodal LLM has capabilities that further comprise:
prompting the user to initiate a video chat and performing a series of dynamically generated tasks aimed at verifying various human factors;
verifying user's identity by comparing the user in the video call to identification documents;
calculating confidence scores for each task; and
evaluating whether the aggregate confidence score meets a predefined threshold.

5. The computer-implemented method of claim 1, wherein the one or more tasks further comprise of:
generating alternative tasks, including the user performing gestures like holding up fingers, placing hands on walls, and interacting with their clothing;
sending a QR code to user's phone, and prompting the user to display it to user's camera;
verifying whether the user is a real person;
confirming their identity matches uploaded documents; and
ensuring the user has not previously created an account for identity verification purposes.

6. The computer-implemented method of claim 1, wherein notifying an administrative user that the calculated confidence scores did not exceed the required threshold further comprising of:
appointing an administrator to manage edge cases that cannot automatically resolve, including scenarios where user's camera captures poor images due to insufficient lighting or technical issues;
handling these cases manually according to predefined procedures; and
establishing a tunable parameter for risk levels to determine when cases are sent for manual review based on the confidence score, where in lower-risk implementations a risk tolerance is set high to minimize manual reviews, and in higher-risk environments, the risk tolerance is set lower to direct more cases for manual review prior to approval.

7. The computer-implemented method of claim 1, wherein the multimodal LLM has capabilities, further comprising:
incorporating newly gathered data after completion of additional tasks;
recalculating the confidence score based on latest tasks completed of the one or more tasks; and
cycling between prompting for further tasks and recalculating the confidence score until the confidence score reaches a minimum threshold while accounting for the time limit.

8. A computer program product comprising:
one or more non-transitory computer readable storage media and program instructions stored on the one or more non-transitory computer readable storage media, the program instructions comprising the steps of:
transmitting, by one or more processors, to a user, a request for identification documentation;
receiving, by the one or more processors, the identification documentation of a user;
assigning, by the one or more processors, an identification factor to the identification documentation;
identifying, by the one or more processors, factors for verification, wherein the factors comprises of the identification factor and one or more task factors;
initiating, by the one or more processors, a video call with the user;
instructing, by the one or more processors, the user to perform one or more tasks within a time limit, wherein each task of the one or more tasks are associated with the one or more task factors;
calculating, by the one or more processors and via a multimodal LLM, a confidence score for each factor of the factors;
comparing, by the one or more processors, a calculated confidence scores to against minimum confidence scores, wherein a minimum confidence score can be user defined or automatically defined by the multimodal LLM;
iteratively, repeating, by the one or more processors, any remaining tasks from the one or more tasks for the user to perform until the time limit has expired;
outputting, by the one or more processors, a final score based on the calculated confidence scores;
determining, by the one or more processors, whether the calculated confidence scores exceeds a required threshold, wherein a required threshold score can be administrative user defined or automatically defined by the multimodal LLM; and
notifying, by the one or more processors, an administrative user that the calculated confidence scores did not exceed the required threshold.

9. The computer program product of claim 8, wherein identifying factors for verification further comprises of, age, gender, height, eye color, hair color, date of birth, place of birth, nationality, residential address, signature, photograph, fingerprints, and any other biometric data such as facial recognition and iris scan.

10. The computer program product of claim 8, wherein calculating, by the one or more processors and via the multimodal LLM, a confidence score for each factor of the factors, further comprises:
determining the confidence score for a single task of the one or more tasks based on an output of a last layer of the multimodal LLM; and
calculating an aggregate confidence score for multiple tasks of the one or more tasks by selecting the task of the one or more tasks with the highest confidence score, computing a simple average of all task scores for the one or more tasks, and applying a weighted average that assigns greater significance to tasks of the one or more tasks performed later in the sequence.

11. The computer program product of claim 8, wherein the multimodal LLM has capabilities that further comprise:
prompting the user to initiate a video chat and performing a series of dynamically generated tasks aimed at verifying various human factors;
verifying user's identity by comparing the user in the video call to identification documents;
calculating confidence scores for each task; and
evaluating whether the aggregate confidence score meets a predefined threshold.

12. The computer program product of claim 8, wherein the one or more tasks further comprise of:
generating alternative tasks, including the user performing gestures like holding up fingers, placing hands on walls, and interacting with their clothing;
sending a QR code to user's phone, and prompting the user to display it to user's camera;
verifying whether the user is a real person;
confirming their identity matches uploaded documents; and
ensuring the user has not previously created an account for identity verification purposes.

13. The computer program product of claim 8, wherein notifying an administrative user that the calculated confidence scores did not exceed the required threshold further comprising of:
appointing an administrator to manage edge cases that cannot automatically resolve, including scenarios where user's camera captures poor images due to insufficient lighting or technical issues;
handling these cases manually according to predefined procedures; and
establishing a tunable parameter for risk levels to determine when cases are sent for manual review based on the confidence score, where in lower-risk implementations a risk tolerance is set high to minimize manual reviews, and in higher-risk environments, the risk tolerance is set lower to direct more cases for manual review prior to approval.

14. The computer program product of claim 8, wherein the multimodal LLM has capabilities, further comprising:
incorporating newly gathered data after completion of additional tasks;
recalculating the confidence score based on latest tasks completed of the one or more tasks; and
cycling between prompting for further tasks and recalculating the confidence score until the confidence score reaches a minimum threshold while accounting for the time limit.

15. A computer system for predicting team dynamics based on changing circumstances, the computer system comprising:
one or more computer processors;
one or more non-transitory computer readable storage media; and
program instructions stored on the one or more non-transitory computer readable storage media, the program instructions comprising the steps of:
transmitting, by one or more processors, to a user, a request for identification documentation;
receiving, by the one or more processors, the identification documentation of a user;
assigning, by the one or more processors, an identification factor to the identification documentation;
identifying, by the one or more processors, factors for verification, wherein the factors comprises of the identification factor and one or more task factors;
initiating, by the one or more processors, a video call with the user;
instructing, by the one or more processors, the user to perform one or more tasks within a time limit, wherein each task of the one or more tasks are associated with the one or more task factors;
calculating, by the one or more processors and via a multimodal LLM, a confidence score for each factor of the factors;
comparing, by the one or more processors, a calculated confidence scores to against minimum confidence scores, wherein a minimum confidence score can be user defined or automatically defined by the multimodal LLM;
iteratively, repeating, by the one or more processors, any remaining tasks from the one or more tasks for the user to perform until the time limit has expired;
outputting, by the one or more processors, a final score based on the calculated confidence scores;
determining, by the one or more processors, whether the calculated confidence scores exceeds a required threshold, wherein a required threshold score can be administrative user defined or automatically defined by the multimodal LLM; and
notifying, by the one or more processors, an administrative user that the calculated confidence scores did not exceed the required threshold.

16. The computer system of claim 15, wherein calculating, by the one or more processors and via the multimodal LLM, a confidence score for each factor of the factors, further comprises:
determining the confidence score for a single task of the one or more tasks based on an output of a last layer of the multimodal LLM; and
calculating an aggregate confidence score for multiple tasks of the one or more tasks by selecting the task of the one or more tasks with the highest confidence score, computing a simple average of all task scores for the one or more tasks, and applying a weighted average that assigns greater significance to tasks of the one or more tasks performed later in the sequence.

17. The computer system of claim 15, wherein the multimodal LLM has capabilities that further comprise:
prompting the user to initiate a video chat and performing a series of dynamically generated tasks aimed at verifying various human factors;
verifying user's identity by comparing the user in the video call to identification documents;
calculating confidence scores for each task; and
evaluating whether the aggregate confidence score meets a predefined threshold.

18. The computer system of claim 15, wherein the one or more tasks further comprise of:
generating alternative tasks, including the user performing gestures like holding up fingers, placing hands on walls, and interacting with their clothing;
sending a QR code to user's phone, and prompting the user to display it to user's camera;
verifying whether the user is a real person;
confirming their identity matches uploaded documents; and
ensuring the user has not previously created an account for identity verification purposes.

19. The computer system of claim 15, wherein notifying an administrative user that the calculated confidence scores did not exceed the required threshold further comprising of:
appointing an administrator to manage edge cases that cannot automatically resolve, including scenarios where user's camera captures poor images due to insufficient lighting or technical issues;
handling these cases manually according to predefined procedures; and
establishing a tunable parameter for risk levels to determine when cases are sent for manual review based on the confidence score, where in lower-risk implementations a risk tolerance is set high to minimize manual reviews, and in higher-risk environments, the risk tolerance is set lower to direct more cases for manual review prior to approval.

20. The computer system of claim 15, wherein the multimodal LLM has capabilities, further comprising:
incorporating newly gathered data after completion of additional tasks;
recalculating the confidence score based on latest tasks completed of the one or more tasks; and
cycling between prompting for further tasks and recalculating the confidence score until the confidence score reaches a minimum threshold while accounting for the time limit.
